(19) United States
(12) Patent Application Publication
(10) Pub. No.: US 2020/0388886 A1
(43) Pub. Date: Dec. 10, 2020

(54) WET MIXTURE, POSITIVE ELECTRODE PLATE, AND METHOD OF PRODUCING LITHIUM ION SECONDARY BATTERY, AND WET MIXTURE, POSITIVE ELECTRODE PLATE, AND LITHIUM ION SECONDARY BATTERY

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi (JP)

(21) Appl. No.: 16/881,545

(22) Filed: May 22, 2020

(30) Foreign Application Priority Data
Jun. 5, 2019 (JP) 2019-104930

(51) Int. Cl. H01M 10/0569; H01M 10/0525; H01M 4/131; H01M 4/70; H01M 4/36

(52) U.S. Cl. CPC H01M 10/0569; H01M 10/0525; H01M 4/131; H01M 2004/028; H01M 4/364; H01M 4/366; H01M 4/70

(57) ABSTRACT

A method of producing a wet mixture includes a solution preparation process in which a lithium conductor forming solution using N-methylpyrrolidone as a solvent is prepared and a solution mixing process in which lithium-containing positive electrode active material particles having surplus lithium compounds on the surface are stirred and the lithium conductor forming solution is mixed with the lithium-containing positive electrode active material particles to obtain a wet mixture containing coated lithium-containing positive electrode active material particles having a lithium conductor coating directly formed on the surface of the lithium-containing positive electrode active material particles without a lithium reduction layer therebetween.

### INCORPORATION BY REFERENCE

The disclosure of Japanese Patent Application No. 2019-104930 filed on Jun. 5, 2019 including the specification, drawings and abstract is incorporated herein by reference in its entirety.

### BACKGROUND

### 1. Technical Field

The present disclosure relates to a wet mixture, a positive electrode plate, and a method of producing a lithium ion secondary battery, and a wet mixture, a positive electrode plate, and a lithium ion secondary battery.

### 2. Description of Related Art

In the related art, in order to improve characteristics of a positive electrode, the surface of positive electrode active material particles made of a lithium-containing composite oxide has been covered with various compounds. For example, WO 2012/176903 describes a technology in which a solution obtained by dissolving an X element-containing compound such as LiF and Li₃PO₄ in an aqueous solvent, particularly, in water, is sprayed onto positive electrode active material particles and dried (refer to Paragraph (0044) and the like).

### SUMMARY

However, it has been found that, when a coating is formed on positive electrode active material particles using a solution using an aqueous solvent, the reaction resistance of a positive electrode plate using the same increases. This is thought to be caused by the fact that, when the surface of polycrystalline positive electrode active material particles comes in contact with water, Li ions are eluted from the surface, a lithium reduction layer having a crystal structure in the vicinity of the surface that is changed is formed, and insertion and release of lithium ions into and from the positive electrode active material particles are prevented.

The present disclosure has been made in view of such problems, and provides a method of producing a wet mixture containing positive electrode active material particles that can constitute a positive electrode plate having a low reaction resistance, a method of producing a positive electrode plate having a low reaction resistance, and a method of producing a lithium ion secondary battery having a low resistance. In addition, the present disclosure provides a wet mixture containing positive electrode active material particles that can constitute a positive electrode plate having a low reaction resistance, a positive electrode plate having a low reaction resistance, and a lithium ion secondary battery having a low resistance.

In order to address the above problem, an aspect of the present disclosure provides a method of producing a wet mixture including a solution preparation process in which a lithium conductor forming solution using N-methylpyrrolidone as a solvent is prepared; and a solution mixing process in which lithium-containing positive electrode active material particles having surplus lithium compounds on the surface are stirred and the lithium conductor forming solution is mixed with the lithium-containing positive electrode active material particles to obtain a wet mixture containing coated lithium-containing positive electrode active material particles having a lithium conductor coating directly formed on the surface of the lithium-containing positive electrode active material particles without a lithium reduction layer therebetween.

In the method of producing a wet mixture, lithium-containing positive electrode active material particles having surplus lithium compounds on the surface are stirred and mixed with a lithium conductor forming solution using N-methylpyrrolidone (N-methyl-2-pyrrolidone, hereinafter also referred to as NMP) as a solvent to obtain a wet mixture. When a lithium conductor forming solution using NMP is brought into contact with lithium-containing positive electrode active material particles as a solvent, unlike the case using an aqueous solvent solution, lithium ions are not eluted from the surface of lithium-containing positive electrode active material particles. Therefore, a wet mixture containing coated lithium-containing positive electrode active material particles on which a lithium conductor coating is directly formed without forming a lithium reduction layer on the surface part of lithium-containing positive electrode active material particles can be obtained.

Therefore, in a lithium ion secondary battery using such coated lithium-containing positive electrode active material particles in a positive electrode layer of a positive electrode plate, during charging, lithium ions released from lithium-containing positive electrode active material particles move toward a negative electrode, and diffuse into an electrolytic solution through a lithium conductor coating having favorable lithium conductivity provided on the surface of the lithium-containing positive electrode active material particles. Thus, lithium ions can be smoothly released into the electrolytic solution from the surface of the lithium-containing positive electrode active material particles. On the other hand, during discharging, lithium ions in a solvation state that have moved to the positive electrode layer reach the lithium conductor coating and enter the lithium-containing positive electrode active material particle via the lithium conductor coating. When the lithium ions enter the lithium-containing positive electrode active material particles, the lithium ions can smoothly enter the lithium-containing positive electrode active material particles through the surface of the lithium-containing positive electrode active material particles. Thus, during the charging and discharging, transfer of lithium ions between the lithium-containing positive electrode active material particles and the electrolytic solution becomes easier, and the reaction resistance of the positive electrode plate, and consequently, the resistance of the lithium ion secondary battery can be reduced.

Here, “lithium-containing positive electrode active material particles” are particles that contain elemental lithium and can occlude and release lithium ions as a positive electrode active material. Regarding such a particle material, a lithium-containing compound containing elemental lithium and one, two or more transition metal elements (for example, a lithium transition metal composite oxide) can be used without particular limitation. Preferred examples thereof include a lithium transition metal oxide having a layered rock salt type or spinel type crystal structure. Examples of such a lithium transition metal oxide include a lithium nickel composite oxide (for example, LiNiO₂), a lithium cobalt composite oxide (for example, LiCoO₂), a lithium manganese composite oxide (for example, LiMn₂O₄), and a ternary lithium-containing composite oxide such as a lithium nickel cobalt manganese composite oxide (for example, LiNi_{1/3}Co_{1/3}Mn_{1/3}O₂). In addition, phosphates containing lithium and a transition metal element as constituent metal elements such as lithium manganese phosphate (for example, LiMnPO₄) and lithium iron phosphate (for example, LiFePO₄) may be exemplified. On the other hand, “lithium reduction layer” is a layer which can be formed on the surface part of the “lithium-containing positive electrode active material particles” and has a composition having a smaller lithium ion content than the original composition.

In addition, “surplus lithium compounds” are lithium compounds (for example, Li₂O, and LiOH) which are present on the surface of lithium-containing positive electrode active material particles and are not a lithium transition metal oxide as the positive electrode active material. “Lithium conductor forming solution” using NMP as a solvent is a solution containing a “lithium conductor precursor” that can form a lithium conductor coating on the surface of active material particles according to a reaction with the surplus lithium compounds on the surface of the lithium-containing positive electrode active material particles. Examples of such a “lithium conductor precursor” include a substance that is dissolved in NMP as a solvent and becomes a lithium conductor according to substitution of Li ions and H ions of surplus lithium compounds (Li₂O, LiOH, and the like) present on the surface of lithium-containing positive electrode active material particles, and specifically, include orthophosphoric acid (H₃PO₄), pyrophosphoric acid (diphosphate, H₄P₂O₇), triphosphoric acid (H₅P₃O₁₀), polyphosphoric acid (H(HPO₃)ₙOH), and phosphoric acid concentrates containing them. In addition, a phosphoric acid-based substance such as lithium hydrogen phosphate (Li₂HPO₄) may be exemplified. In addition, examples of a substance other than phosphoric acid-based substances include tungstic acid (H₂WO₄) and niobic acid (HNbO₃). In addition, examples of a “lithium conductor coating” formed on the surface of the lithium-containing positive electrode active material particles include coatings made of Li₃PO₄, Li₂HPO₄, LiH₂PO₄, Li₂WO₄, LiHWO₄, LiNbO₃ or the like. Regarding the “lithium conductor coating,” a low crystalline coating, and specifically, an amorphous coating may be used in order to increase lithium ion conductivity. Thus, in obtaining the wet mixture or coated lithium-containing positive electrode active material particles, it is preferable to avoid performing a heat treatment at a high temperature exceeding 500° C. after the coating is formed. For example, a method of vacuum drying under heating at 100° C. can be used.

In addition, the “wet mixture” is a non-fluid substance in which powder formed of coated lithium-containing positive electrode active material particles formed by mixing is wetted with NMP contained in a lithium conductor forming solution and becomes wet. The solid content ratio (a proportion of the solid content) NV in such a wet mixture may be generally 70% or more and preferably 90% or more.

In addition, the above method of producing a wet mixture may be a method of producing a wet mixture containing at least one of Li₂O and LiOH on the surface as the surplus lithium compounds on the lithium-containing positive electrode active material particles.

In the method of producing a wet mixture, since the lithium-containing positive electrode active material particles contain at least one of Li₂O and LiOH on the surface as the surplus lithium compounds, a coating made of a lithium conductor such as Li₃PO₄, Li₂HPO₄, LiH₂PO₄, Li₂WO₄, LiHWO₄, and LiNbO₃ can be reliably formed by applying the lithium conductor forming solution.

In addition, in the method of producing a wet mixture according to any one of the above methods, in the lithium conductor forming solution, at least one of orthophosphoric acid (H₃PO₄), pyrophosphoric acid (H₄P₂O₇), triphosphoric acid (H₅P₃O₁₀), polyphosphoric acid (H(HPO₃)ₙOH), and phosphoric acid concentrates may be dissolved in the method of producing a wet mixture.

In the method of producing a wet mixture, a lithium conductor precursor forming a lithium phosphate is dissolved as a lithium conductor such as orthophosphoric acid (H₃PO₄) in the lithium conductor forming solution. When a phosphate compound such as orthophosphoric acid is used, it is possible to produce a wet mixture at lower cost compared to other substances serving as a lithium conductor such as tungstic acid (H₂WO₄) and niobic acid (HNbO₃).

In addition, in the method of producing a wet mixture according to any one of the above methods, the lithium conductor coating may contain at least one of lithium phosphate (Li₃PO₄), lithium hydrogen phosphate (Li₂HPO₄), and lithium dihydrogen phosphate (LiH₂PO₄) in the method of producing a wet mixture.

In the method of producing a wet mixture, the lithium conductor coating formed on the coated lithium-containing positive electrode active material particles becomes a lithium phosphate coating containing at least one of lithium phosphate (Li₃PO₄), lithium hydrogen phosphate (Li₂HPO₄), and lithium dihydrogen phosphate (LiH₂PO₄). Therefore, inexpensive coated lithium-containing positive electrode active material particles can be obtained, which is more preferable.

In the coated lithium-containing positive electrode active material particles of the wet mixture, the thickness of the lithium phosphate coating is preferably thin, the thickness is, for example, 0.5 nm to several nm, and a very thin coating with a thickness of 0.5 nm to 1.5 nm (of several atoms) is preferable.

Another solution is to provide a method of producing a positive electrode plate including an undried positive electrode layer forming process in which an undried positive electrode layer containing the wet mixture produced in the method of producing a wet mixture according to any one of the above methods is formed on a positive electrode current collecting plate and a drying process in which the undried positive electrode layer is dried and a positive electrode layer is formed on the positive electrode current collecting plate.

In the method of producing a positive electrode plate, the positive electrode layer obtained by drying the wet mixture is formed on the positive electrode current collecting plate. In addition, since the coated lithium-containing positive electrode active material particles are obtained without first drying the wet mixture, it is possible to omit a number of processes and cost for drying the wet mixture, and production is possible at low cost. Therefore, it is possible to produce a positive electrode plate having a positive electrode layer containing coated lithium-containing positive electrode active material particles having favorable lithium ion conductivity and having a low reaction resistance at low cost.

Here, in the undried positive electrode layer forming process, an appropriate method can be used as a method of forming an undried positive electrode layer on the positive electrode current collecting plate. Examples thereof include a method using a die coater, a method of performing coating using a blade on a positive electrode current collecting plate, and a method in which a wet mixture is granulated once to form a wet granulated substance, and an undried positive electrode layer is formed on a positive electrode current collecting plate using a three-roll transfer device.

Still another solution is to provide a method of producing a lithium ion secondary battery including an electrode body forming process in which an electrode body is formed using the positive electrode plate produced in the above method of producing a positive electrode plate. Alternatively, a method of producing a lithium ion secondary battery including an electrode body forming process in which an electrode body is formed using a positive electrode plate containing the coated lithium-containing positive electrode active material particles contained in the wet mixture produced in the method of producing a wet mixture according to any one of the above methods in the positive electrode layer is preferable.

In such a method of producing a lithium ion secondary battery, since an electrode body is formed using the above positive electrode plate having a low reaction resistance, it is possible to produce a lithium ion secondary battery having a low resistance.

Here, the “lithium ion secondary battery” is a secondary battery which uses lithium ions as electrolyte ions and performs charging and discharging according to movement of lithium ions between positive and negative electrodes. In this specification, the type of a negative electrode active material constituting a negative electrode plate and a solvent constituting a non-aqueous electrolytic solution, a battery capacity, and the form are not limited, and appropriate materials, forms and the like can be used.

Yet another solution is to provide a wet mixture including coated lithium-containing positive electrode active material particles containing lithium-containing positive electrode active material particles and a coating made of a lithium conductor directly formed on the surface of the lithium-containing positive electrode active material particles without a lithium reduction layer therebetween and N-methylpyrrolidone.

The wet mixture contains coated lithium-containing positive electrode active material particles having favorable lithium ion conductivity and NMP. Therefore, when the wet mixture is applied to a positive electrode current collecting plate and dried, a positive electrode plate having a low reaction resistance can be easily obtained. Alternatively, when the wet mixture is dried, coated lithium-containing positive electrode active material particles having favorable lithium ion conductivity can be obtained.

In addition, yet another solution is to provide a positive electrode plate having a positive electrode layer containing the coated lithium-containing positive electrode active material particles by drying the above wet mixture on a positive electrode current collecting plate.

Since the positive electrode plate has a positive electrode layer containing coated lithium-containing positive electrode active material particles, a positive electrode plate having a low reaction resistance can be obtained.

In addition, yet another solution is to provide a lithium ion secondary battery having an electrode body including the above positive electrode plate. Alternatively, a lithium ion secondary battery having an electrode body using a positive electrode plate containing the coated lithium-containing positive electrode active material particles contained in the above wet mixture in a positive electrode layer is preferable.

When the above positive electrode plate having a low reaction resistance is used in such a lithium ion secondary battery, a battery used can be a battery having a low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing a process of producing a wet mixture, a positive electrode plate, and a battery according to an embodiment;

FIG. 2A is a schematic view showing a surface state of a lithium-containing positive electrode active material particle as a starting material;

FIG. 2B is a schematic view showing a surface state of a coated lithium-containing positive electrode active material particle in which a coating is formed on the surface of a lithium-containing positive electrode active material particle having a lithium reduction layer on its surface according to a comparative embodiment;

FIG. 2C is a schematic view showing a surface state of a coated lithium-containing positive electrode active material particle in which a coating is formed on its surface according to an embodiment;

FIG. 3A is an SEM image obtained by observing the surface of a lithium-containing positive electrode active material particle in which a coating is formed according to an embodiment;

FIG. 3B is an EDS image showing a distribution of phosphorus present on the surface of the lithium-containing positive electrode active material particle;

FIG. 4 is a graph showing a magnitude of a reaction resistance in sample batteries according to an embodiment, with no treatment (without mixing with a lithium conductor forming solution), and formed using a positive electrode plate produced using a wet mixture according to a comparative embodiment mixed with an aqueous lithium conductor forming solution;

FIG. 5 is a perspective view of a positive electrode plate according to an embodiment; and

FIG. 6 is a perspective view of a battery according to an embodiment.

### DETAILED DESCRIPTION OF EMBODIMENTS

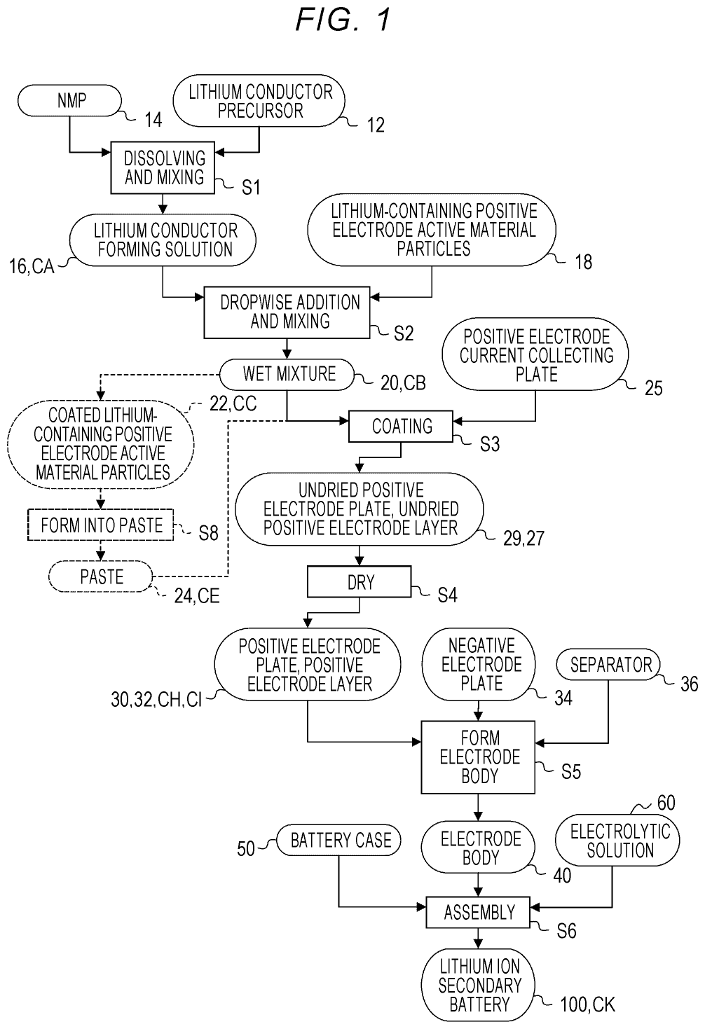

Hereinafter, embodiments of the present disclosure will be described with reference to the drawings. Here, in the drawings to be described below, members and portions having the same functions are denoted with the same reference numerals and redundant descriptions will be omitted or simplified. In addition, the sizes (a length, a width, a thickness, and the like) in the drawings do not reflect actual sizes. In addition, components other than those particularly mentioned in this specification that are necessary for implementation can be recognized by those skilled in the art as design matters based on the related art in the field. FIG. 1 is a flowchart showing a process of producing a wet mixture, a positive electrode plate, and a battery according to an embodiment.

First, production of a wet mixture 20 will be described. First, in a dissolving and mixing process (solution preparation process) 51, a lithium conductor precursor 12 is mixed with and dissolved in N-methylpyrrolidone (NMP) 14 to obtain a lithium conductor forming solution 16. The lithium conductor precursor 12 is a substance that reacts with surplus lithium compounds 19 such as Li₂O and LiOH present on a surface 18S of the lithium-containing positive electrode active material particles 18 and can form a lithium conductor coating 23 on the surface 18S when lithium-containing positive electrode active material particles 18 to be described below are brought into contact with the lithium conductor forming solution 16. In the present embodiment, regarding the lithium conductor precursor 12, a phosphoric acid concentrate obtained by heating and concentrating orthophosphoric acid (H₃PO₄) with a concentration of 85% to 80% is used. The phosphoric acid concentrate includes orthophosphoric acid (H₃PO₄), pyrophosphoric acid (H₄P₂O₇), triphosphoric acid (H₅P₃O₁₀), and polyphosphoric acid (H(HPO₃)ₙOH). Specifically, the phosphoric acid concentrate (lithium conductor precursor) 12 is added to N-methylpyrrolidone (NMP) 14, and mixed and dissolved to have a concentration of 10 wt %.

Here, in the lithium conductor precursor 12, in addition to the above phosphoric acid concentrate, orthophosphoric acid (H₃PO₄), pyrophosphoric acid (H₄P₂O₇), or triphosphoric acid (H₅P₃O₁₀) is preferably used. This is because phosphoric acid-based substances are relatively inexpensive. In addition, tungstic acid (H₂WO₄), and niobic acid (HNbO₃) can also be used.

Next, in a dropwise addition and mixing process (solution mixing process) S2, the lithium-containing positive electrode active material particles 18 having the surplus lithium compounds 19 on the surface 18S are stirred and the lithium conductor forming solution 16 is added dropwise to and mixed with the lithium-containing positive electrode active material particles 18. Specifically, 200 g of the lithium-containing positive electrode active material particles 18 are weighed out and put into a mixer (not shown), which is closed with a lid. The mixer is driven at 800 rpm for 5 seconds, and the lithium-containing positive electrode active material particles 18 are stirred and loosened. Then, an input port of the mixer is opened, and within the first 10 seconds of driving the mixer at 800 rpm for 15 seconds, 5 g of the lithium conductor forming solution 16 divided using a syringe is added dropwise and mixed in. The lid of the mixer is opened, and the lithium-containing positive electrode active material particles 18 are mixed with a spatula (particles 18 attached to a stirring blade of the mixer and the like are mixed in). In addition, the lid of the mixer is closed, the mixer is driven at 800 rpm for 15 seconds, and the lithium-containing positive electrode active material particles 18 and the lithium conductor forming solution 16 are mixed together. The lid of the mixer is opened again, and a mixture of the lithium-containing positive electrode active material particles 18 and the lithium conductor forming solution 16 is mixed with a spatula. The input port of the mixer is opened, and within the first 10 seconds of driving the mixer at 800 rpm for 15 seconds, 5 g of the lithium conductor forming solution 16 divided using a syringe is added dropwise and mixed in (a total of 10 g is added). The lid of the mixer is opened again, and a mixture of the lithium-containing positive electrode active material particles 18 and the lithium conductor forming solution 16 is mixed with a spatula. In addition, the lid of the mixer is closed, and the mixer is driven at 800 rpm for 15 seconds to stir the mixture.

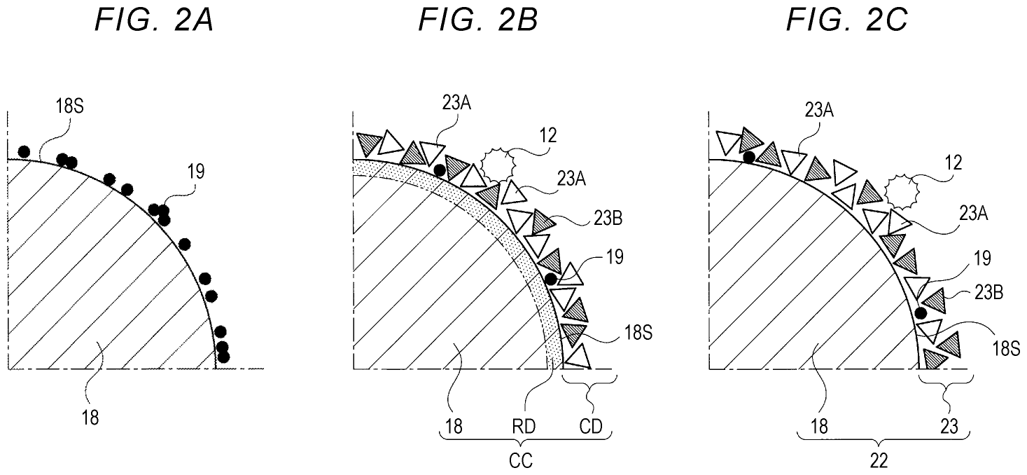

Here, in the present embodiment, regarding the lithium-containing positive electrode active material particles 18, lithium nickel cobalt manganese composite oxide (LiNi_{1/3}Co_{1/3}Mn_{1/3}O₂) is used. The surplus lithium compounds 19 such as Li₂O and LiOH are present on the surface 18S of the lithium-containing positive electrode active material particles 18 (refer to FIG. 2A).

When the lithium conductor forming solution 16 is brought into contact with the lithium-containing positive electrode active material particles 18, the surplus lithium compounds 19 such as Li₂O and LiOH present on the surface 18S react with polyphosphoric acid or the like contained in the lithium conductor forming solution 16, and are changed to a lithium phosphate conductor 23A made of Li₃PO₄ or the like or to a lithium hydrogen phosphate conductor 23B made of Li₂HPO₄, LiH₂PO₄, or the like according to substitution of Li ions and H ions. Thus, the coating 23 which has a thickness of about 1 nm, is made of an amorphous lithium conductor, and has favorable lithium ion conductivity is directly formed on the surface 18S (refer to FIG. 2C). Here, it is sufficient that the thickness of the coating 23 be very thin, and the thickness is, for example, 0.5 to several nm, and a very thin coating with a thickness of 0.5 nm to 1.5 nm is preferable.

Thus, in the dropwise addition and mixing process S2, without a lithium reduction layer RD (refer to FIG. 2B) therebetween, the wet mixture 20 including coated lithium-containing positive electrode active material particles 22 having the lithium conductor coating 23 directly formed on the surface 18S of the lithium-containing positive electrode active material particles 18 can be obtained. Here, the wet mixture 20 of the present embodiment has a solid content ratio NV of 95%.

Thus, the wet mixture 20 contains the coated lithium-containing positive electrode active material particles 22 having favorable lithium ion conductivity and NMP 14. Therefore, as will be described below, the wet mixture 20 is applied to a positive electrode current collecting plate 25 and dried and thus a positive electrode plate 30 having a low reaction resistance can be easily obtained. Alternatively, if the wet mixture 20 is dried, the coated lithium-containing positive electrode active material particles 22 having favorable lithium ion conductivity can be obtained.

In particular, in the production method of the present embodiment, since the lithium-containing positive electrode active material particles 18 include Li₂O and LiOH as surplus lithium compounds on the surface 18S, when the lithium conductor forming solution 16 is applied, the coating 23 made of a lithium conductor such as Li₃PO₄, Li₂HPO₄, LiH₂PO₄, Li₂WO₄, LiHWO₄, and LiNbO₃ can be reliably formed.

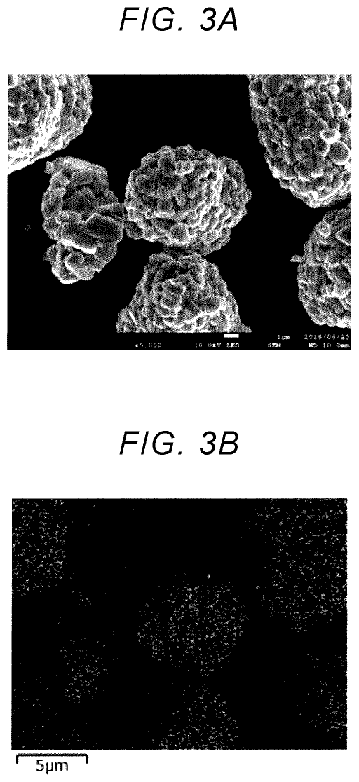

Here, the presence of the coating 23 formed on the surface 18S of the lithium-containing positive electrode active material particles 18 can be confirmed by analysis using a general X-ray analysis method. In addition, confirmation may be performed by detecting a specific element (for example, elemental phosphorus) present on the surface of a positive electrode active material based on energy dispersive X-ray spectroscopy (EDS analysis method) using an analytical instrument. FIG. 3A is an SEM image obtained by observing the surface of coated lithium-containing positive electrode active material particles 22 according to an embodiment. FIG. 3B is an EDS image showing a distribution of phosphorus present on the surface of coated lithium-containing positive electrode active material particles 22.

It is found in FIGS. 3A and 3B that, since elemental phosphorus is uniformly distributed on the surface of the coated lithium-containing positive electrode active material particles 22, the coating 23 made of lithium phosphate or the like is uniformly formed.

In the production method of the present embodiment, in the lithium conductor forming solution 16, the lithium conductor precursor 12 forming a lithium phosphate is dissolved as a lithium conductor such as orthophosphoric acid (H₃PO₄). A phosphate compound such as orthophosphoric acid is more preferable because it allows a wet mixture to be produced at lower cost than other substances that become a lithium conductor such as tungstic acid (H₂WO₄) and niobic acid (HNbO₃). In addition, the lithium conductor coating 23 formed on the coated lithium-containing positive electrode active material particles 22 is a lithium phosphate coating containing at least one of lithium phosphate (Li₃PO₄), lithium hydrogen phosphate (Li₂HPO₄), and lithium dihydrogen phosphate (LiH₂PO₄). Thus, this is more preferable because inexpensive coated lithium-containing positive electrode active material particles 22 can be obtained.

Here, in the coated lithium-containing positive electrode active material particles 22 forming the wet mixture 20 of the present embodiment, the lithium conductor coating 23 is directly formed on the surface 18S of the lithium-containing positive electrode active material particles 18 without the lithium reduction layer RD therebetween (refer to FIG. 2C). This is because a non-aqueous solvent NMP 14 is used as the solvent of the lithium conductor forming solution 16 instead of water. Therefore, as will be described below, it is possible to reduce the reaction resistance of a lithium ion secondary battery 100 using the positive electrode plate 30 having the coated lithium-containing positive electrode active material particles 22 on a positive electrode layer 32.

Next, production of the positive electrode plate 30 will be described. In a coating process (undried positive electrode layer forming process) S3, the wet mixture 20 is mixed with a conductive material (carbon black), a binding agent, and the like, and applied to the positive electrode current collecting plate 25, and thereby an undried positive electrode plate 29 having an undried positive electrode layer 27 is formed.

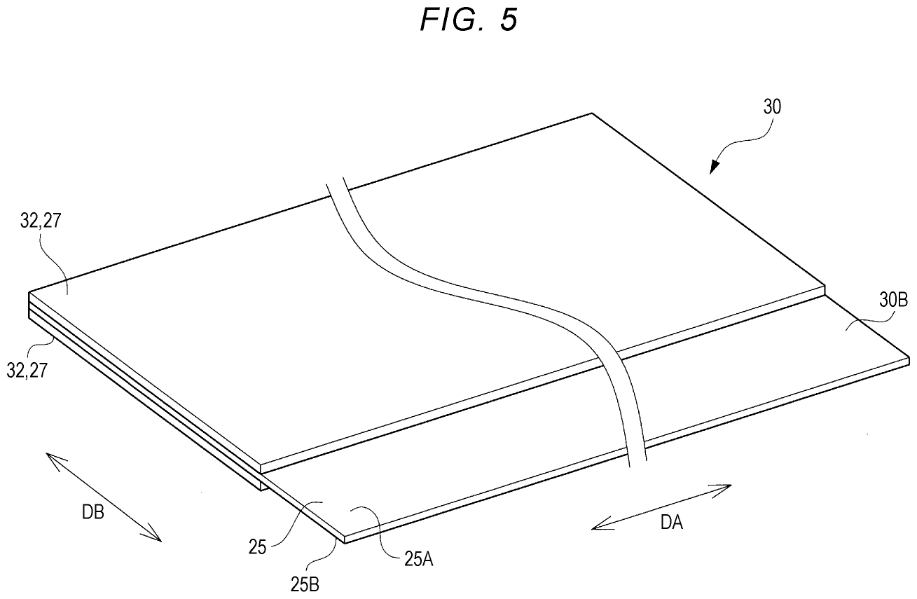

In addition, in a drying process S4, the undried positive electrode plate 29 is heated, and NMP 14 is vaporized, the undried positive electrode layer 27 is dried, and the positive electrode plate 30 having the positive electrode layer 32 is formed. Here, the coating process S3 and the drying process S4 are repeated, and the positive electrode layer 32 is formed on both surfaces 25A and 25B of the positive electrode current collecting plate 25 (refer to FIG. 5). Here, the positive electrode plate 30 shown in FIG. 5 has a strip shape that is long in a longitudinal direction DA and has one side in a width direction DB (a lower right direction in FIG. 5) on which a positive electrode current collecting part 30B in which the positive electrode current collecting plate 25 is exposed is provided. In addition, when the undried positive electrode plate 29 is heated and dried in the drying process S4, in order to avoid crystallization of the amorphous coating 23 and decrease in lithium ion conductivity, the drying temperature may be set to 500° C. or lower. In addition, the drying temperature may be selected in consideration of a melting point and the like of the binding agent and the like contained in the positive electrode layer 32. For example, a method such as vacuum drying under heating at 100° C. may be used.

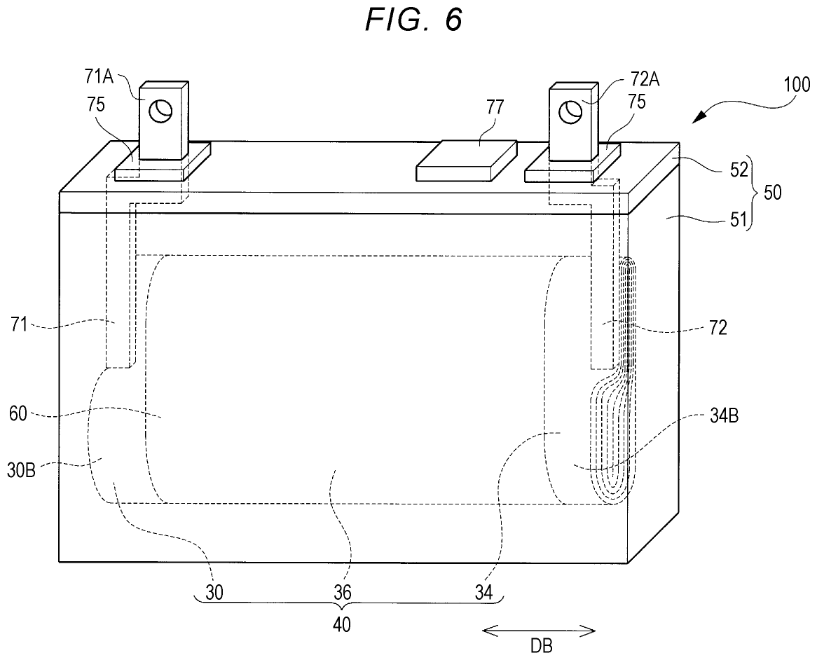

In addition, in an electrode body forming process S5, an electrode body 40 is formed using the positive electrode plate 30 together with a negative electrode plate 34 and a separator 36 which are separately prepared according to a known method. In the present embodiment, the strip-like negative electrode plate 34 and separator 36 are prepared, and these are wound to form a flat wound electrode body 40 (refer to FIG. 6). At both ends of the electrode body 40, the positive electrode current collecting part 30B and a negative electrode current collecting part 34B are exposed.

In addition, in an assembly process S6, the battery (lithium ion secondary battery) 100 is constructed using a battery case 50, an electrolytic solution 60, and the like which are separately prepared. Specifically, a lid part 52 to which a positive electrode terminal member 71 and a negative electrode terminal member 72 are fixed via an insulating member 75 is prepared, and the positive electrode terminal member 71 is connected to the positive electrode current collecting part 30B of the electrode body 40. In addition, the negative electrode terminal member 72 is connected to the negative electrode current collecting part 34B of the electrode body 40. The electrode body 40 is inserted into a case main body 51, the case main body 51 is blocked with the lid part 52, and the periphery is fixed by laser welding. The electrolytic solution 60 is injected through an injection hole (not shown), and the electrolytic solution 60 is impregnated with the electrode body 40 in the case main body 51. Then, the battery 100 is activated (initially charged) using a positive electrode external terminal part 71A and a negative electrode external terminal part 72A protruding from the lid part 52, and the injection hole is then sealed with a sealing member 77 and the inside of the battery 100 is sealed. Thereby, the battery 100 is completed.

Here, in the above embodiment, without obtaining the coated lithium-containing positive electrode active material particles 22 by drying the wet mixture 20, in the coating process S3, the wet mixture 20 is mixed with a conductive material, a binding agent, and the like and applied to the positive electrode current collecting plate 25, and thereby the undried positive electrode plate 29 is formed.

However, as indicated by dotted lines in FIG. 1, the wet mixture 20 is dried to obtain the coated lithium-containing positive electrode active material particles 22, and then, in a pasting process S8, a conductive material, a binding agent, and the like, and a non-aqueous solvent are mixed together to form a paste 24, and in the coating process S3, the paste is applied to the positive electrode current collecting plate 25, and the undried positive electrode plate 29 having the undried positive electrode layer 27 may be formed.

However, unlike the wet mixture 20 that is dried once to obtain the coated lithium-containing positive electrode active material particles 22 as indicated by dotted lines, as in the present embodiment indicated by solid lines, if the coating process (undried positive electrode layer forming process) S3 in which the wet mixture 20 without drying is used and the undried positive electrode layer 27 containing the wet mixture 20 is formed and the drying process S4 in which the undried positive electrode layer 27 is dried and the positive electrode layer 32 is formed on the positive electrode current collecting plate 25 are provided, a number of processes and cost for drying the wet mixture 20 can be omitted and production is possible at low cost. Therefore, the positive electrode plate 30 having the positive electrode layer 32 containing the coated lithium-containing positive electrode active material particles 22 having favorable lithium ion conductivity and having a low reaction resistance can be produced at low cost. In addition, since the positive electrode layer 32 containing the coated lithium-containing positive electrode active material particles 22 is provided, the positive electrode plate 30 having a low reaction resistance can be obtained. In addition, in a method of producing the lithium ion secondary battery 100, since the electrode body 40 is formed using the above positive electrode plate 30 having a low reaction resistance, it is possible to produce the lithium ion secondary battery 100 having a low resistance. In addition, since the positive electrode plate 30 having a low reaction resistance is used, the lithium ion secondary battery 100 having a low resistance can be obtained as a battery.

### Comparative Embodiment

In a comparative embodiment, in place of the lithium conductor forming solution 16 using NMP 14 as a solvent, water is used as a solvent and a lithium conductor forming solution CA in which orthophosphoric acid (H₃PO₄) is dissolved is obtained in the dissolving and mixing process S1, and in the dropwise addition and mixing process S2, the solution is added dropwise to and mixed with the lithium-containing positive electrode active material particles 18 to obtain a wet mixture CB. In addition, when the wet mixture CB is dried (water is evaporated), coated lithium-containing positive electrode active material particles CC having a coating CD can be obtained.

In the coated lithium-containing positive electrode active material particles CC according to the comparative embodiment, the lithium reduction layer RD is formed on the part of the surface 18S of the lithium-containing positive electrode active material particles 18. This is because lithium ions in the vicinity of the surface 18S of the lithium-containing positive electrode active material particles 18 elute into water (refer to FIG. 2B). Also on the coated lithium-containing positive electrode active material particles CC, the coating CD made of a lithium conductor is formed, but the lithium reduction layer RD is interposed between the coating CD and the lithium-containing positive electrode active material particles 18. Therefore, in a lithium ion secondary battery CK using a positive electrode plate CH having the coated lithium-containing positive electrode active material particles CC on a positive electrode layer CI, it is not possible to reduce the reaction resistance. This is because the lithium reduction layer RD is interposed and thus transfer of lithium ions between the lithium-containing positive electrode active material particles 18 and the electrolytic solution 60 is prevented by the lithium reduction layer RD. Here, the lithium reduction layer RD of the coated lithium-containing positive electrode active material particles CC is very thin, but can be observed through a transmission electron microscope (TEM) or electron energy loss spectroscopy using a transmission electron microscope (TEM-EELS).

<Production of Positive Electrode Plates of Embodiment, and Comparative Embodiment, and Reference, and Preparation of Lithium Ion Secondary Batteries (Sample Battery and Control Battery) for Evaluation Test>

The coated lithium-containing positive electrode active material particles 22, CC, or untreated lithium-containing positive electrode active material particles 18, carbon black as a conductive material, and polyvinylidene fluoride as a binder were weighed out at a mass ratio of 90:9:1, and these were dispersed in NMP 14 to prepare positive electrode pastes. These positive electrode pastes 24 and CE were applied to the positive electrode current collecting plate 25, vacuum-dried and then subjected to a rolling process using a press machine, and thereby positive electrode sheets of the embodiment and the comparative embodiment were produced.

Next, a positive electrode plate prepared by punching each positive electrode sheet into a 2 cm² circular shape, and a counter electrode made of metallic lithium were set to face each other with a separator therebetween to construct a sample battery. Regarding an electrolytic solution of the sample battery, a non-aqueous electrolytic solution in which 1 M LiPF₆ was dissolved in a non-aqueous solvent prepared by mixing ethylene carbonate, dimethyl carbonate, and ethyl methyl carbonate at a volume ratio of 3:4:3 was used. Here, a battery using the lithium-containing positive electrode active material particles 18 without the coating 23 formed thereon without using the lithium conductor forming solution 16 was prepared as control battery.

<Activation (Initial Charging)>

The above sample battery and control battery were activated (initially charged). Specifically, under a temperature condition of −30° C., constant current (CC) charging was performed at a current of 1C until the battery voltage reached 4.1 V, and constant voltage (CV) charging was then performed until the current value became 1/50 C, and a fully charged state was reached. Then, CC discharging was performed at a current of 1 C until the battery voltage reached 3.0 V.

<Measurement of Reaction Resistance of Batteries>

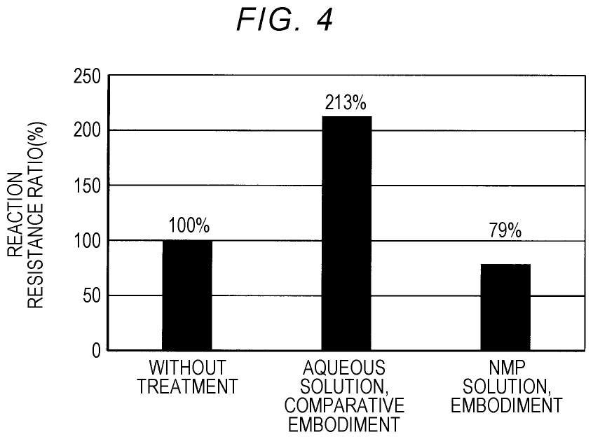

In the above activated batteries, under a temperature condition of −30° C., CC charging was performed at 1 C, and the state was adjusted to a state of charge (SOC) of 27%. Then, CC discharging was performed at 10 C for 10 seconds, and an initial battery resistance (IV resistance) was determined from the slope of a primary approximation curve of the current (I)-voltage (V) plot value at this time. Then, the ratio of the IV resistance of the sample batteries according to the embodiment and the comparative embodiment when the IV resistance of the control battery (no treatment) was set as a reference (100%) was defined as a reaction resistance ratio of each battery. The results are shown in Table 1 and FIG. 4.

TABLE 1

| | | Reaction resistance |
|---|---|---|
| | Treatment | ratio (%) |
| Without treatment | No treatment | 100 |
| Comparative embodiment | Aqueous solution | 213 |
| Embodiment | NMP solution | 79 |

The reaction resistance of the battery using the coated lithium-containing positive electrode active material particles CC according to the comparative embodiment was significantly higher than the reaction resistance of the battery using “untreated” lithium-containing positive electrode active material particles 18. This is because, in the comparative embodiment, the lithium-containing positive electrode active material particles 18 were treated with the lithium conductor forming solution CA using water as a solvent, the lithium reduction layer RD was formed on the surface 18S of the lithium-containing positive electrode active material particles 18, and the coating CD made of a lithium conductor was formed, but the lithium reduction layer RD was interposed between the coating CD and the lithium-containing positive electrode active material particles 18, and transfer of lithium ions between the lithium-containing positive electrode active material particles 18 and the electrolytic solution 60 was prevented by the lithium reduction layer RD.

On the other hand, the reaction resistance of the battery using the coated lithium-containing positive electrode active material particles 22 according to the embodiment was reduced by about 20% compared to the reaction resistance of the battery using the “untreated” lithium-containing positive electrode active material particles 18. It was understood that, unlike the coated lithium-containing positive electrode active material particles CC according to the comparative embodiment, in the coated lithium-containing positive electrode active material particles 22 according to the embodiment, there was no lithium reduction layer RD, and the coating 23 was directly formed on the surface 18S of the lithium-containing positive electrode active material particles 18, and thus transfer of lithium ions between the lithium-containing positive electrode active material particles 18 and the electrolytic solution 60 was facilitated by the coating 23 made of a lithium conductor.

While the present disclosure has been described above according to the embodiments, the present disclosure is not limited to the above embodiments, but can be appropriately modified and applied without departing from the spirit and scope thereof. While a phosphoric acid concentrate was used in the lithium conductor forming solution 16 in the above embodiment, orthophosphoric acid (H₃PO₄), pyrophosphoric acid (H₄P₂O₇) and the like can be used.

In addition, in the above embodiment, in the dropwise addition and mixing process (solution mixing process) S2, the lithium-containing positive electrode active material particles 18 were stirred and the lithium conductor forming solution 16 was added dropwise to the lithium-containing positive electrode active material particles 18 using a syringe and mixed in. However, in addition to a method of dropwise addition of the lithium conductor forming solution 16, various methods may be used as a method of mixing the solution 16 with the lithium-containing positive electrode active material particles 18, such as spraying toward the lithium-containing positive electrode active material particles 18.

What is claimed is:

1. A method of producing a wet mixture, comprising:
a solution preparation process in which a lithium conductor forming solution using N-methylpyrrolidone as a solvent is prepared; and
a solution mixing process in which lithium-containing positive electrode active material particles having surplus lithium compounds on the surface are stirred and the lithium conductor forming solution is mixed with the lithium-containing positive electrode active material particles to obtain a wet mixture containing coated lithium-containing positive electrode active material particles having a lithium conductor coating directly formed on the surface of the lithium-containing positive electrode active material particles without a lithium reduction layer therebetween.

2. The method according to claim 1,
wherein the lithium-containing positive electrode active material particles have at least one of Li₂O and LiOH on the surface as the surplus lithium compounds.

3. The method according to claim 1,
wherein, in the lithium conductor forming solution, at least one of orthophosphoric acid (H₃PO₄), pyrophosphoric acid (H₄P₂O₇), triphosphoric acid (H₅P₃O₁₀), polyphosphoric acid (H(HPO₃)ₙOH), and phosphoric acid concentrates is dissolved.

4. The method according to claim 1,
wherein the lithium conductor coating contains at least one of lithium phosphate (Li₃PO₄), lithium hydrogen phosphate (Li₂HPO₄), and lithium dihydrogen phosphate (LiH₂PO₄).

5. A method of producing a positive electrode plate, comprising:
an undried positive electrode layer forming process in which an undried positive electrode layer containing the wet mixture produced in the method of producing a wet mixture according to claim 1 is formed on a positive electrode current collecting plate; and
a drying process in which the undried positive electrode layer is dried and a positive electrode layer is formed on the positive electrode current collecting plate.

6. A method of producing a lithium ion secondary battery, comprising
an electrode body forming process in which an electrode body is formed using the positive electrode plate produced in the method of producing a positive electrode plate according to claim 5.

7. A wet mixture, comprising:
coated lithium-containing positive electrode active material particles including lithium-containing positive electrode active material particles, and a coating made of a lithium conductor directly formed on the surface of the lithium-containing positive electrode active material particles without a lithium reduction layer therebetween; and
N-methylpyrrolidone.

8. A positive electrode plate having a positive electrode layer containing the coated lithium-containing positive electrode active material particles obtained by drying the wet mixture according to claim 7 on a positive electrode current collecting plate.

9. A lithium ion secondary battery comprising an electrode body including the positive electrode plate according to claim 8.
